(19) United States
(12) Patent Application Publication
(10) Pub. No.: US 2008/0110132 A1
(43) Pub. Date: May 15, 2008

(54) Automated bags supply system for filling bags with products

(75) Inventors: Julio Ricardo Yan Ruz, Metepec (MX); Cesar Perez Monroy, Nicolas Romero (MX)

Correspondence Address: FISH & RICHARDSON P.C., P.O. BOX 1022, MINNEAPOLIS, MN, 55440-1022, US

(73) Assignee: Grupo Bimbo, S.A.B. de C.V.

(21) Appl. No.: 11/983,834

(22) Filed: Nov. 13, 2007

(30) Foreign Application Priority Data
Nov. 14, 2006 (MX) PA/A/2006/013229

(51) Int. Cl. B65B 43/26; B65B 43/30; G06F 19/00

(52) U.S. Cl. 53/459; 53/384.1; 53/385.1; 53/386.1; 53/492; 700/117

(57) ABSTRACT

An automated bag supply system delivers bags to a point below the dosing and discharge area of a specific product filing station. In a first embodiment, a system for supplying bags may include a tray, a bag separating device, and a support mechanism for the bag separating device. In a second embodiment, a system for supplying bags automatically may include a support for a plurality of unopened bags disposed vertically, an arm with suction elements and an actuator, two semi-concave sections, and a driving mechanism coupled to each of the semi-concave sections.

### CLAIM OF PRIORITY

This application claims priority to Mexican Patent Application Serial No. PA/a/2006/013229 filed on Nov. 14, 2006, the entire contents of which are hereby incorporated by reference.

### TECHNICAL FIELD

The present invention relates to providing containers, and more particularly, to providing bags to a product filling area.

### BACKGROUND

Food and non-food products have different consistencies, shapes, dimensions, and sizes, including granulated and non-granulated products. In general, the products are conditioned or packed to improve the preservation of their physical and organoleptic properties, protect the products from environmental conditions, inhibit contamination of the products, and inhibit degradation of the composition and the structure of the product due to environmental humidity. In addition, packing food and non-food products allows better handling and transportation of the products to destinations where the products will be purchased by the final consumers.

The packing of a great variety of food and non-food products is manual, which may cause damage to the products, and, in certain cases, may increase the possibility of product contamination. Manual packing may also cause low production volumes and high production costs due to the labor required.

While automated packing equipment exists, many of these include a variety of parts that are difficult to manufacture and are highly complex systems and mechanisms.

### SUMMARY

Various implementations include systems, processes, and apparatus for the management, the handling, and the conditioning of different products. An automated bag supply system provides the bags to a point below the filling and discharge area of the specific product.

In one general implementation, a system for supplying bags to a product filling station includes a tray and a bag separating device. The tray may be configured to hold a plurality of unfilled bags. The bag separating device may include at least one suction element. The suction element may couple to one of the unfilled bags in the tray. The bag separating device may include an actuator, which may move the bag separating device proximate the tray such that the bag separating device couples to one of the bags disposed in the tray using the suction element. The bag separating device may also include a support mechanism. The support mechanism may be connected to the bag separating device. The support mechanism may include a first end including a first opening element and a second end including a second opening element. The first opening element and the second opening element may be disposed to face each other. The first opening element and the second opening element may couple to the bag coupled to the bag holding and separating device, dispose the bag proximate the product filing area, and open the opening of the bag. A second actuator may be coupled to the first opening element and a third actuator may be coupled to the second opening element. The first opening element and the second opening element are operated by the second and the third actuators. The first and the second opening elements may cause the first opening element and the second opening element to open the unsealed entrance to the bag.

Various implementations may include one or more of the following features. The tray may retain the plurality of unopened bags horizontally in the tray. The first and the second opening elements may include suction elements. The first and the second opening elements may also include foot valves operable to form a vacuum in the first and the second opening elements. The system may include an arm, where the support mechanism is disposed on the arm. The arm may be curved with a pivotal joint positioned in the curved portion of the arm. The system may include a stirring element. The stirring element may include at least one actuator that shakes the bag once product has been deposited inside the bag. Each actuator may be selected from the group consisting of: pneumatic, hydraulic, electromechanical, or servomotor actuators. The system may include a software-assisted electronic control system to control and synchronize the operation of elements of the system for supplying bags automatically.

In another general aspect, the system for supplying bags automatically to a product filling station may include a support, an arm, semi-concave sections, and a driving mechanism. The support adapted to hold a plurality of unopened bags may dispose the bags vertically with an unsealed end disposed up. The arm may include suction elements and an actuator. The suction elements, disposed on the arm and opposite the support, may couple to one of the bags retained by the support. An actuator may move the arm proximate the support such that the suction elements couple to the bag and may move the bag coupled to the suction elements proximate the product filling area. The semi-concave sections may be disposed toward each other and may be moveably positioned above the unsealed end of the unopened bag. The driving mechanism may be coupled to each of the semi-concave sections. The driving mechanism may at least partially insert the two semi-concave sections into the bag proximate the discharge area and may separate the two-semi-concave sections to at least partially open the unsealed end of the unopened bag.

Various implementations may include one or more features. The system may include a blower disposed above the bag proximate the discharge area. The blower may blow air into an unsealed end of the bag and separate opposing walls of the bag. The two opposite semi-concave sections may be at least partially inserted into the unsealed opened bag. The system may include a stirring element. The stirring element may include at least one actuator that shakes the bag once product has been deposited inside the bag. The actuators may be selected from the group consisting of pneumatic, hydraulic, electromechanical, or servomotor actuator. At least one of the driving mechanisms may include at least one of a pneumatic, a hydraulic, an electromechanical, or a servomotor actuator. The system may include a software-assisted electronic control system, which may control and synchronize the operation of elements of the system for supplying bags.

In another general aspect, a process performed by the system may automatically supply unfilled bags to the product filling area. A bag may be disposed in a tray of a plurality of bags and may be coupled to the system by a bag separating device. The bag may be removed from the tray. Two opposing side walls of the bag may be coupled to by the opening elements. The opening elements may be retracted such that the side walls of the bag are at least partially separated and the bag may be disposed proximate a product filling area.

Various implementations may include one or more features. The bag may be agitated using a stirring element disposed below the bag. Product may be dispensed into the bag in the product filling area.

The details of one or more implementations of the invention are set forth in the accompanying drawings and the description below. Other features, objects, and advantages will be apparent from the description and drawings, and from the claims.

### DESCRIPTION OF DRAWINGS

FIG. 1 illustrates a perspective view of an automated bags supply system for filling bags with different products, in a first position.

FIG. 2 illustrates a perspective view of the automated bag supply system illustrated in FIG. 1 in a second position holding a bag for its transportation to the product filling area.

FIG. 3 illustrates a perspective view of the automated bag supply system illustrated in FIG. 1 with a bag in a third position positioned vertically below the product discharge and supply area.

FIG. 4 illustrates a perspective view of the automated bag supply system illustrated in FIG. 1 in a fourth position opening of the bag below the product filling area.

FIG. 5 illustrates a side perspective view of a vertical type embodiment of an automated bag supply system for filling bags with different products, in a first position.

FIG. 6 illustrates a perspective view of the vertical type automated bags supply system of FIG. 5 holding a bag from the supply of bags.

FIG. 7 illustrates a perspective of the vertical type automated bags supply system of FIG. 5, removing and starting to open a bag.

FIG. 8 illustrates a front perspective of the vertical type automated bags supply system of FIG. 5, in an opening position, in which mechanical openers (“flippers”) hold the bag before filling the bag with product.

FIG. 9 illustrates an example system for controlling and synchronizing operation of elements of an automated bag supply system.

FIG. 10 illustrates a flowchart of an example process of an embodiment of an automated bag supply system.

Like reference symbols in the various drawings indicate like elements.

### DETAILED DESCRIPTION

In various implementations, the automated bag supply system may be used with different food products The bag supply system may be simple, fast, efficient, functional, and/or significantly decrease the processing times and operating costs. The bag supply system may also allow the continuous filling (“dosing”) of bags for the packaging of different products.

A feature of the automated bag supply system is the ability to supply the bags one by one at a point below the filling “dosing” area of the specific product and then to condition the bags to appropriately receive the related product. Another feature of the automated bag supply system inhibits product damage, contamination, and/or waste during product packaging. The automated bags supply system may be simple, fast, and efficient, and it may decrease processing times and operating costs and increase production and productivity. An additional feature of the invention is that the automated bags supply system may ensure that the product is deposited inside the bags in a gentle, simple and efficient manner. Another feature of the automated bags supply system includes inhibiting damage to the bag during handling.

In a first embodiment, the automated bags supply system may include a deposit of bags to supply a mechanism for bag holding and separation that holds a bag and separates the bag from the deposit of bags, and a bags entrance holding and opening mechanism that holds and opens the bag below the area where the product to be packaged is discharged.

In some implementations, the deposit of bags includes a tray in which a plurality of bags is disposed. The mechanism for bag holding and separation holds and separates a bag from the deposit of bags. The mechanism for bag holding and separation includes a bag holding and separation device with a suctioning device and a first actuator. The first actuator moves the bag holding and separation device over the deposit of bags. The suction device then holds the bag using suction (e.g., by creating a vacuum) and the actuator lifts the bag in a predetermined position.

The bag entrance holding and opening mechanism includes an arm. The arm includes a second actuator on one end and a third actuator on the opposite end that is coupled to a mechanism with holding elements. The holding elements use suction (e.g., vacuum or negative pressure), or any other holding system, to hold a bag and allow mechanical openers, which are driven by the actuators and have an appropriate shape, to prepare the bag for disposing the product into the bag.

During a first stage of operation, the arm retracts by the second actuator disposed on an end of the arm, to move the mechanism with holding elements close to an end of the bag that is lifted by the bag holding and separating device. The arm also retracts the third actuator on the opposite end in such a way that the mechanism with the holding elements, where the holding elements are disposed parallel to the separated bag end, moves in the same vertical axis. The operating elements move proximate their corresponding mechanical openers and are driven by their corresponding actuators to hold the unsealed end of the bag from the proximal side of the bag opening.

In a second stage of operation, the arm extends in a synchronized way through the second actuator and the third actuator to dispose the bag in a vertical position below the product discharge area and, subsequently, the actuators of the mechanical openers retract to open the unsealed entrance end of the bag.

The holding elements may include a suction device, foot valves to control the suction device, or any other appropriate holding system. The holding elements hold the walls of the bag, move the bag, and then open the bag opening.

In another embodiment, the deposit of bags may be disposed vertically. The upper end of a number of vertically disposed bags may be held by the system. The bags holding and separation elements include a straight arm disposed transversely. The straight arm includes suction elements disposed proximate the proximal sides of the exterior of the bag. The transverse straight arm is operated by an actuator that extends to move the arm proximate the deposit of bags and can hold the proximal side of the bag. The actuator of the straight arm retracts to separate the front bag and move the bag proximate the lower area, where the discharge means of the product to be packaged is located. Above this area is transversely disposed the bag holding and entrance opening element. The bag holding and entrance opening element includes two semi-concave sections opposite each other. The semi-concave sections are substantially separated and include a driving means that moves them in a descending direction, partially lowering the sections and depositing them inside the opening of the bag to keep the bag open. The driving means also pivotally moves the semi-concave sections to partially separate the sections from their lower end to hold, by pressure, the upper end of the bag. The semi-concave sections exert pressure on the internal face of the bag wall proximate the entrance while product is deposited. Once the product has been deposited in the bag, the semi-concave sections move to release the opening of the bag and the bag. With a lifting movement, the semi-concave sections are lifted and returned to the original rest position.

In some implementations, a blowing means may be attached and/or disposed over the bags deposit. The blowing means is directed toward the opening of a bag just as it is withdrawn from the deposit of vertically disposed bags and, thus, facilitates the insertion of the two opposite semi-concave sections into the bag entrance to hold and keep the bag open.

The determined number of deposited bags deposits, a bags holding and separation means, and the corresponding bags holding and entrance means are disposed in predetermined positions to simultaneously package a large quantity of product, increase productivity, and decrease the operating costs of the process, which significantly increases the cost-benefit ratio in the industrial processes of packaging different products.

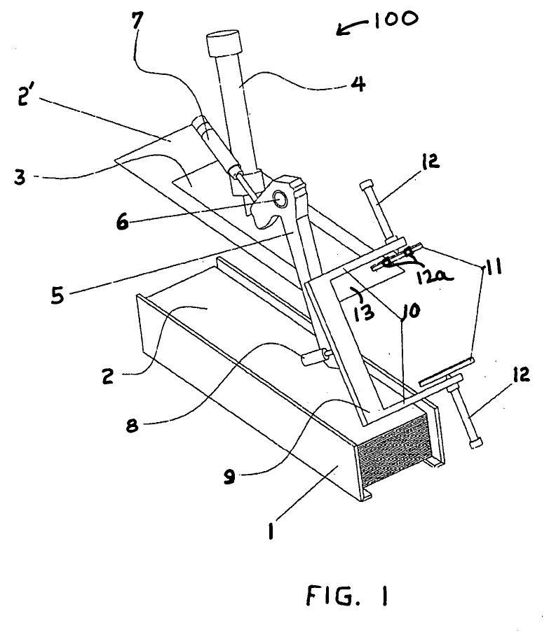

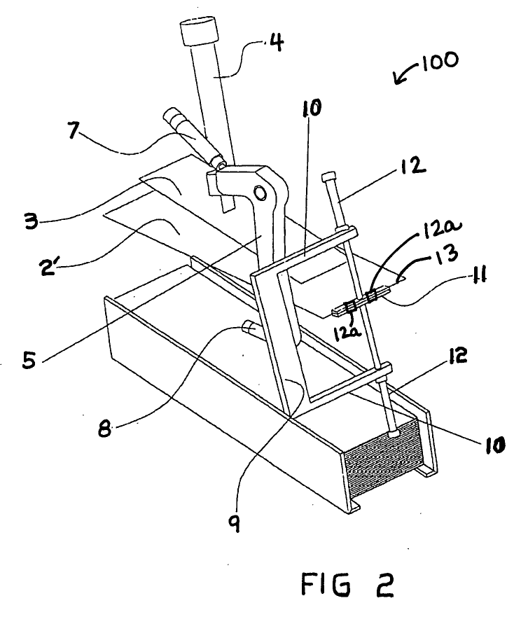

FIG. 1 illustrates a perspective view of a first embodiment of an automated bag supply system 100 for filling bags with different products, in a first or resting position. The system 100 includes a tray 1 in which a plurality of bags 2 are disposed. As illustrated, the bags 2 are disposed horizontally. Disposed above the tray 1 is a bag holding and separating device 3 with a suctioning device 12a. The bag holding and separating device 3 is activated by a first actuator 4 attached to a support frame (not shown). Referring to FIG. 2, when the actuator 4 expands, the actuator 4 moves the bag holding and separating device 3 over the tray 1 with the bags 2. The suctioning device 12a of the bag holding and separating device 3 holds a bag 2′ by suction pressure. When the actuator 4 retracts, the bag holding and separating device 3 lifts (e.g., moves away from the tray 1) the bag 2 to a predetermined lifted position.

Referring to FIG. 1, an arm 5 is disposed over the bag holding and separating device 3. The arm 5 may be capable of moving to a position parallel to the bag holding and separating device 3. The arm 5 is curved and includes a pivoting joint 6 in the curved section of the arm 5. The arm has a supporting structure (not shown) that includes a second actuator 7 connected to an end of the arm proximate to the bag holding and separating device 3. The second actuator 7 is a driving element for extending and withdrawing the opposite end of the arms. The second end of the arm has a third actuator 8 connected thereto. The third actuator 8 is connected to a U-shaped support frame 9. Each end 10 of the U-shaped support frame 9 includes actuators 12 coupled to opening elements 11. The opening elements 11 are disposed inside the U-shaped frame 9 to face each other. Each opening element is actuated by an actuator 12 that moves the opening element to hold the bag, separating at least a portion of walls of the bag to open the bag opening.

FIG. 2 illustrates the system 100 of FIG. 1 holding a bag 2′. The retracted actuator 4 positions the bag holding and separating device 3, which holds the bag 2′, in a lifted position. The second actuator 7 and the third actuator 8 of the arm 5 are retracted, and, thus, the end of the arm, where the support frame 9 of the opening elements 11 is disposed, is partially lowered and proximate the bag 2′ held by the bag holding and separating device 3. The actuators 12 on each end 10 of the U-shaped support frame 9 are extended so that the opening elements 11 hold the unsealed entrance end 13 of the bag 2′.

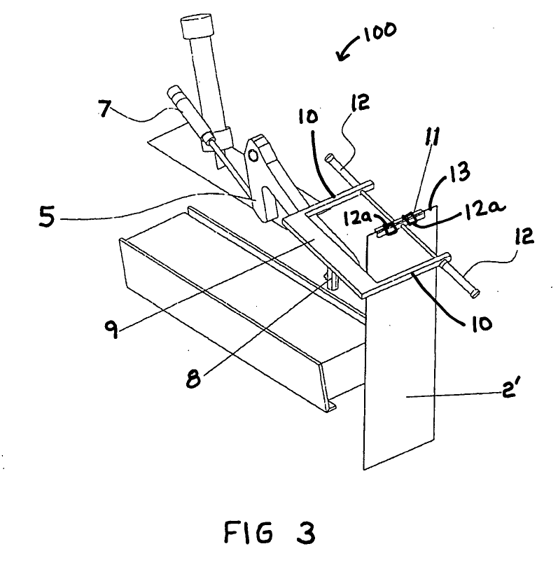

FIG. 3 illustrates system 100, with a bag 2′ positioned proximate a product discharge area. The second actuator 7, coupled to the end of the arm 5, expands to move the opposite end of the arm closer to the area below the area where the product will be discharged and deposited in the bag 2′. In addition, the third actuator 8, which is extended, disposes in the U-shaped support frame 9 and the opening elements 11 in a horizontal position and disposes the bag 2′ in a vertical position. The unsealed entrance end 13 of bag 2′ may be held by the opening elements 11.

The opening elements 11 include a suction device 12a that generates a vacuum. The suctioning device 12a holds the walls of the bags 2′ so that the unsealed entrance end of bag 2′ can be opened.

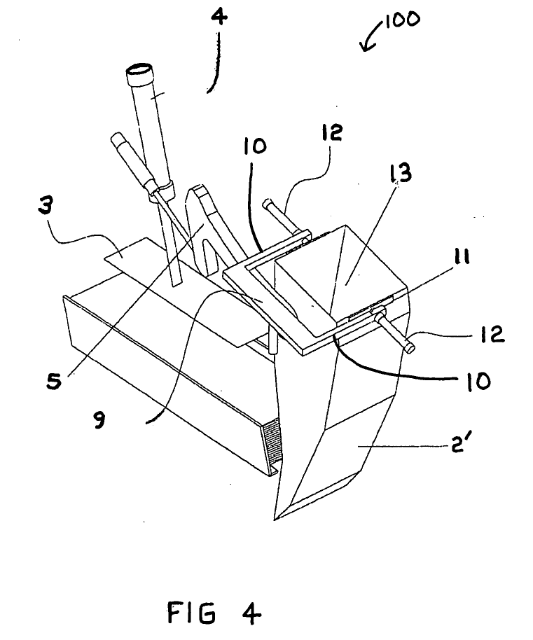

FIG. 4 illustrates system 100, in which an opening of a bag 2′ is opened. The actuators 12, on each end 10 of the U-shaped support frame 9 that is coupled to the opening elements 11, retract to pull the opening elements 11 as the suction device of each opening element holds an opposing wall of the bag 2′. Thus, as the walls of the bag 2′ separate, the unsealed entrance 13 of the bag 2′ opens to receive the product to be packaged. The bag holding and separating device 3 may be lowered (in some implementations, concurrently lowered) by the actuator 4 to take another bag and repeat the cycle.

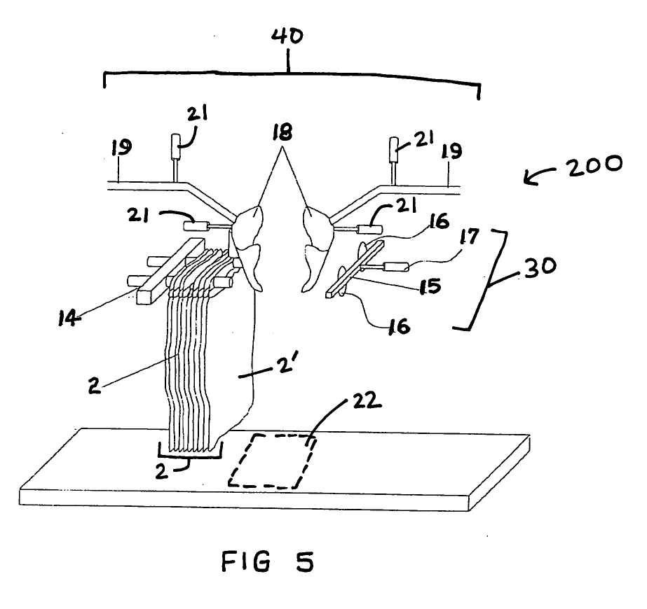

FIG. 5 illustrates another embodiment of an automated bags supply system 200 for filling bags with different products, in a first or resting position. The system 200 includes bags 2 that are vertically disposed. The system 200 includes an elevated support 14 that holds the upper ends of a plurality of bags 2 disposed vertically. The system 200 includes a bags holding and separation mechanism 30 disposed opposite the bags 2. The bags holding and separation mechanism 30 includes an arm 15 that is approximately straight. The arm 15 is disposed transversely and includes suction elements 16. The suction elements 16 may be disposed in front of and facing the front side of the bags. The arm 15 is operated by an actuator 17, connected to a frame (not shown), that extends to move the arm 15 proximate to the bags 2 to hold the front of a bag 2′. When the actuator 17 of the arm 15 retracts, the front bag is separated from the bags and the bag 2′ is moved closer to the lower area where the discharge mechanism of the product to be packaged is disposed.

Disposed above the arm 15 is the bag holding and entrance opening mechanism 40. The bag holding and entrance opening mechanism 40 includes two semi-concave sections 18 disposed opposite each other. As illustrated, the semi-concave sections 18 are separated. The activators 21 disposed on driving mechanism 19 move the semi-concave sections 18 in a descending direction to partially lower, move or separate the semi-concave sections 18 to hold and open the unsealed bag opening.

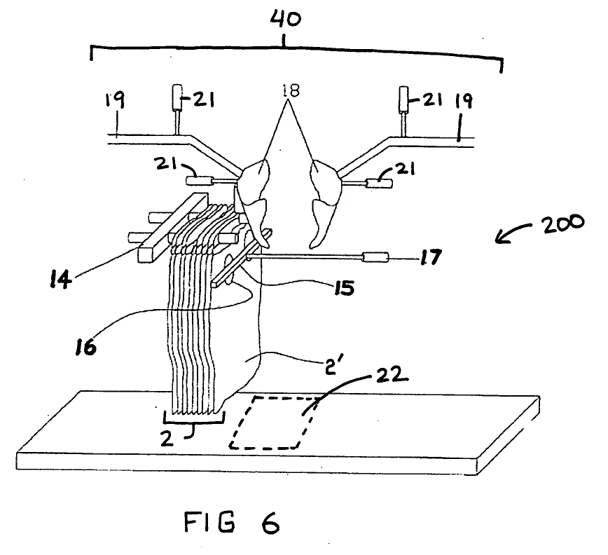

FIG. 6 illustrates system 200, in which a bag 2′ is held. The actuator 17 extends to move the arm 15 toward the elevated support 14 that holds the bags 2 and, using the suction elements 16, holds the front bag 2′.

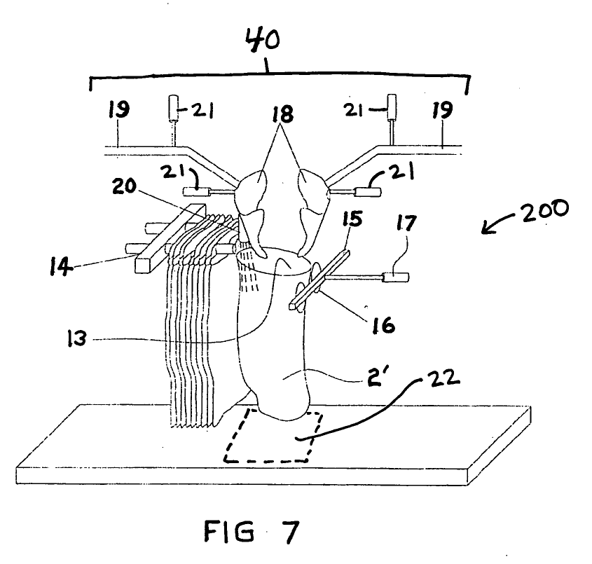

FIG. 7 illustrates system 200, in which a bag 2′ is being opened. As illustrated, the actuator 17 is activated and retracts the arm 15 that holds the bag 2′ using the suction elements 16. A blower 20 is coupled to system 200 and disposed at least partially above the elevated support 14. The blower 20 blows air which causes the separation of the bag walls and therefore opens the bag 2′ opening 13.

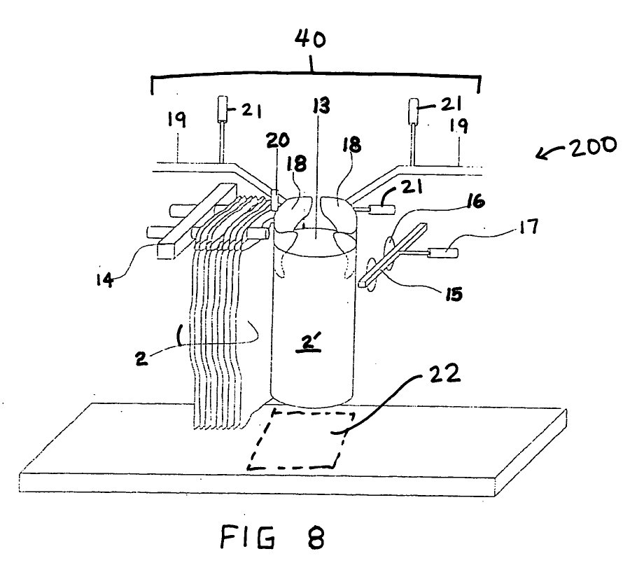

FIG. 8 illustrates system 200, in which the bag 2′ is being held open. Using the air blown from the blower 20 allows the insertion of the two semi-concave sections 18 into the unsealed bag opening 13 to hold and keep the bag 2′ open. The semi-concave sections 18 are inserted at least partially into the bag by the action of the driving mechanism 19. The two semi-concave sections 18 are lowered by the driving mechanism 19 and at least partially inserted in the bag 2′ opening 13. Then, the upper ends of the two semi-concave sections 18 are separated, by the driving mechanism 19, to hold the bag open by applying pressure to the upper end of the bag 2′, which applies pressure to the internal face of the bag 2′ wall around the unsealed opening 13. The bag 2′ may be held open by the semi-concave sections 18 while the product is being deposited. Once the product has been deposited, the semi-concave sections 18 may be moved to release the opening 13 of the bag 2′ and to release the bag. A third lifting movement of the driving mechanism 19 may return the semi-concave sections to their resting position.

In addition, the system, such as systems 100 and 200, may include stirring mechanisms 22 that include at least one actuator that shakes the bag once product has been deposited inside the bag. The stirring mechanism 22 may be disposed below the bag when the bag is disposed in the area where product is deposited into the bag. The stirring mechanism may vertically agitate the bag. Shaking the bag may facilitate proper arrangement of the contents of the bag. Shaking the bag may also cause the bag to have more planar bottom surface (e.g., a flat base). A more planar bottom surface of the bag may reduce the likelihood that the bag will tip or fall over when the bag is positioned on a conveyor belt (e.g., for further processing after product has been disposed in the bag).

The actuators 4, 7, 8, 12, 17 may be pneumatic, hydraulic, electromechanical, and/or servomotor actuators.

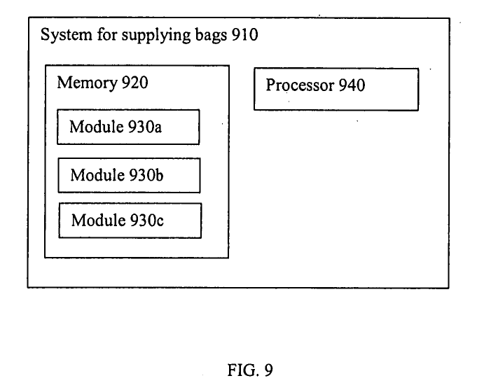

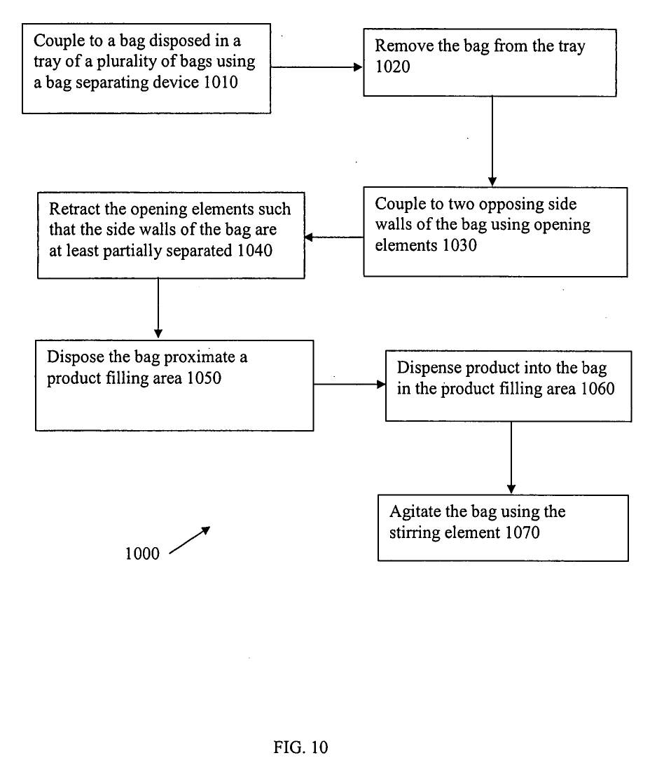

In some implementations, the system 910 includes a memory 920 on which modules 930a, 930b, 930c (e.g., software) are stored, as illustrated in FIG. 9. The modules 930a, 930b, 930c may be executed by a processor 940 and may include an assisted electronic control system that automates, controls, and synchronizes the operation of all the elements of the system. The module may provide correct operation of the system. For example, the system 910 may cause various components (e.g., bag separating device, arms, semi-concave sections, driving mechanisms, actuators, etc.) of the system to perform one or more operations similar to the process illustrated in FIG. 10.

As illustrated in FIG. 10, a bag disposed in a tray of a plurality of bags is coupled to using a bag separating device (operation 1010). The bag is removed from the tray (operation 1020). Two opposing side walls of the bag are coupled to using opening elements (operation 1030). The opening elements are retracted such that the side walls of the bag are at least partially separated (operation 1040). The bag may be disposed proximate the product filling area (operation 1050). Product may be dispensed into the bag in the product filling area (operation 1060). The bag may be agitated by the stirring element (operation 1070).

Several implementations have been described, and a number of others have been mentioned or suggested. Furthermore, those skilled in the art will readily recognize that a variety of modifications, substitutions, deletions, and/or additions may be made to these implementations while still achieving automated packaging. The scope of the protected subject matter, therefore, is to be determined on the basis of the following claims, which may encompass one or more aspects of one or more of the implementations.

It is to be understood the implementations are not limited to particular systems or processes described, which may, of course, vary. It is also to be understood that the terminology used herein is for the purpose of describing particular implementations only, and is not intended to be limiting. As used in this specification, the singular forms “a”, “an”, and “the” include plural references unless the content clearly indicates otherwise.

What is claimed is:

1. A system for supplying bags to a product filling station, the system comprising:
a tray configured to hold a plurality of unfilled bags;
a bag separating device comprising:
at least one suction element operable to couple to one of the unfilled bags in the tray;
a first actuator operable to move the bag separating device proximate the tray such that the bag separating device couples to one of the bags disposed in the tray using the suction element;
a support mechanism connected to the bag separating device comprising:
a first end including a first opening element; and
a second end including a second opening element, wherein the first opening element and the second opening element are disposed to face each other, and wherein the first opening element and the second opening element are operable to:
couple to the bag coupled to the bag holding and separating device;
dispose the bag proximate the product filing area; and
open the opening of the bag; and
a second actuator coupled to the first opening element and a third actuator coupled to the second opening element, wherein the first opening element and the second opening element are operated by the second and the third actuators, and wherein the first and the second opening elements are operable to cause the first opening element and the second opening element to open the unsealed entrance to the bag.

2. The system of claim 1 wherein the tray is configured to retain the plurality of unopened bags horizontally in the tray.

3. The system of claim 1 wherein the first and the second opening elements comprise suction elements.

4. The system of claim 1 wherein the first and the second opening elements further include foot valves operable to form a vacuum in the first and the second opening elements.

5. The system of claim 1 further comprising an arm, wherein the support mechanism is disposed on the arm, and wherein the arm is curved with a pivotal joint positioned in the curved portion of the arm.

6. The system of claim 1 further comprising a stirring element, the stirring element comprising at least one actuator that shakes the bag once product has been deposited inside the bag.

7. The system of claim 1 wherein each actuator is selected from the group consisting of: pneumatic, hydraulic, electromechanical, or servomotor actuators.

8. The system of claim 1 further comprising a software-assisted electronic control system operable to control and synchronize the operation of elements of the system for supplying bags automatically.

9. A system for supplying bags automatically to a product filling station, the system comprising:
a support adapted to hold a plurality of unopened bags disposed vertically with an unsealed end disposed up;
an arm comprising:
suction elements, the suction elements disposed on the arm opposite the support and operable to couple to one of the bags retained by the support; and
a first actuator operable to move the arm proximate the support such that the suction elements couple to the bag and operable to move the bag coupled to the suction elements proximate the product filling area;
two semi-concave sections disposed towards each other and moveably positioned above the unsealed end of the unopened bag; and
a driving mechanism coupled to each of the semi-concave sections, wherein the driving mechanisms are operable to at least partially insert the two semi-concave sections into the bag proximate the discharge area and operable to separate the two-semi-concave sections to at least partially open the unsealed end of the unopened bag.

10. The system of claim 9 further comprising a blower disposed above the bag proximate the discharge area, the blower operable to blow air into an unsealed end of the bag and separate opposing walls of the bag.

11. The system of claim 9 wherein the two opposite semi-concave sections are at least partially inserted into the unsealed opened bag.

12. The system of claim 9 further comprising a stirring element, the stirring element comprising at least one actuator that shakes the bag once product has been deposited inside the bag.

13. The system of claim 9 wherein the actuators are selected from the group consisting of pneumatic, hydraulic, electromechanical, or servomotor actuator.

14. The system of claim 9 wherein at least one of the driving mechanisms comprises at least one of a pneumatic, a hydraulic, an electromechanical, or a servomotor actuator.

15. The system of claim 9 further comprising a software-assisted electronic control system operable to control and synchronize the operation of elements of the system for supplying bags.

16. A method for automatically supplying unfilled bags to a product filling area, the method comprising:
coupling to a bag disposed in a tray of a plurality of bags using a bag separating device;
removing the bag from the tray;
coupling to two opposing side walls of the bag using opening elements;
retracting the opening elements such that the side walls of the bag are at least partially separated; and
disposing the bag proximate the product filling area.

17. The method of claim 16 further comprising agitating the bag using a stirring element disposed below the bag.

18. The method of claim 16 further comprising dispensing product into the bag in the product filling area.

19. A process control system for automatically supplying unfilled bags to a product filling area, the process control system comprising:
a processor;
a memory; and
a stored program for executing the steps comprising:
coupling to a bag disposed in a tray of a plurality of bags using a bag separating device;
removing the bag from the tray;
coupling to two opposing side walls of a bag using opening elements;
retracting the opening elements such that the side walls of the bag are at least partially separated; and
disposing the bag proximate a product filling area.

20. A system for supplying unfilled bags to a product filling area, the system comprising:
a tray configured to hold a plurality of bags;
a bag separating device comprising:
at least one suction element, wherein at least one of the suction elements couples to one of the unfilled bags in the tray; and
a first actuator, wherein the first actuator moves the bag separating device proximate the tray such that the bag separating device couples to one of the unfilled bags disposed in the tray using at least one of the suction elements; and
a support mechanism for the bag separating device comprising:
a first end including a first opening element;
a second end including a second opening element, wherein the first opening element and the second opening element are disposed to face each other, and wherein the first opening element and the second opening element:
couple to the unfilled bag coupled to the bag holding and separating device;
dispose the bag proximate the product filling area; and
open the opening of the bag; and
a first actuator coupled to the first opening element and a third actuator coupled to the second opening element, where the first opening element and the second opening element are operated by the second and the third actuators, and wherein the first and the second opening elements open the unsealed entrance of the bag.

21. A system for supplying unfilled bags to a product filling area, the system comprising:
a support adapted to hold a plurality of unopened bags disposed vertically with an unsealed end disposed up;
an arm comprising:
suction elements disposed opposite the support, wherein the suction elements couple to one of the bags retained by the support; and
a first actuator, wherein the first actuator moves the arm proximate the support such that the suction elements couple to the bag and move the bag coupled to the suction elements proximate the product filling area;
two semi-concave sections disposed toward each other and movably positioned above the unsealed end of the unopened bag; and
a driving mechanism coupled to each of the semi-concave sections, wherein the driving mechanisms at least partially insert the two semi-concave sections into the bag proximate the discharge area and separate the two-semi-concave sections to at least partially open the unsealed end of the unopened bag.
